(19) United States
(12) Patent Application Publication
(10) Pub. No.: US 2025/0369761 A1
(43) Pub. Date: Dec. 4, 2025

(54) METHOD AND APPARATUS FOR DETERMINING MOVEMENT PATH OF VEHICLE IN CONSIDERATION OF MOVEMENT FLOW OF PASSENGERS

(71) Applicant: 42DOT INC., Seoul (KR)

(72) Inventor: Ji Seong KIM, Yongin (KR)

(21) Appl. No.: 18/681,923

(22) PCT Filed: Jul. 28, 2022
(86) PCT No.: PCT/KR2022/011113

§ 371 Date: Jan. 23, 2025

(30) Foreign Application Priority Data
Aug. 23, 2021 (KR) 10-2021-0110986

(51) Int. Cl. G01C 21/34; G06Q 50/40

(52) U.S. Cl. CPC G01C 21/343; G06Q 50/40

(57) ABSTRACT

The present disclosure relates to a method and apparatus for determining a movement path of a vehicle considering a movement flow of passengers.

In the method according to an embodiment of the present disclosure, boarding/alighting information for each time slot for each of a plurality of boarding/alighting points may be obtained, and departure/arrival information for each passenger may be obtained based on the boarding/alighting information for each time slot. In addition, in the method according to an embodiment of the present disclosure, at least one passenger movement flow vector for each time slot may be determined based on the departure/arrival information for each passenger, and a movement path of a vehicle may be determined based on the passenger movement flow vector for each time slot.

### TECHNICAL FIELD

The present disclosure relates to a method and apparatus for determining a movement path of a vehicle considering a movement flow of passengers.

### BACKGROUND ART

The number of boarding passengers and the number of alighting passengers for each boarding/alighting point of a vehicle may be collected. The numbers of boarding passengers and the numbers of alighting passengers in different time slots may greatly differ from each other even for the same boarding/alighting point.

For example, during a home-to-work commuting time slot, there are mainly commuting trips of workers from their homes to workplaces, and commuting trips of students using public transport (e.g., buses) to get to schools, and during an after-school time slot in a daytime, there are a lot of trips of students from schools to a private teaching institutes area. In addition, during a work-to-home commuting time slot, there are a lot of commuting trips of workers from workplaces to their homes.

Accordingly, there is a need for a technique for determining a movement path of a vehicle by calculating directions of trips of passengers and the number of passengers for each time slot.

The above-mentioned background art is technical information possessed by the inventor for the derivation of the present disclosure or acquired during the derivation of the present disclosure, and cannot necessarily be said to be a known technique disclosed to the general public prior to the filing of the present disclosure.

### DISCLOSURE

### Technical Problem

The present disclosure provides a method and apparatus for determining a movement flow of a vehicle considering a movement flow of passengers. Technical objectives of the present disclosure are not limited to the foregoing, and other unmentioned objectives or advantages of the present disclosure would be understood from the following description and be more clearly understood from the embodiments of the present disclosure. In addition, it would be appreciated that the objectives and advantages of the present disclosure may be implemented by means provided in the claims and a combination thereof.

### Technical Solution

According to a first aspect of the present disclosure, there may be provided a method of determining a movement path of a vehicle considering a movement flow of passengers, the method including: obtaining boarding/alighting information for each time slot for each of a plurality of boarding/alighting points; obtaining departure/arrival information for each passenger based on the boarding/alighting information for each time slot; determining at least one passenger movement flow vector for each time slot based on the departure/arrival information for each passenger; and determining a movement path of a vehicle based on the passenger movement flow vector for each time slot.

According to a second aspect of the present disclosure, there may be provided an apparatus for determining a movement path of a vehicle considering a movement flow of passengers, the apparatus including: a memory storing at least one program; and a processor configured to execute the at least one program to perform an operation, wherein the processor is further configured to obtain boarding/alighting information for each time slot for each of a plurality of boarding/alighting points, obtain departure/arrival information for each passenger based on the boarding/alighting information for each time slot, determine at least one passenger movement flow vector for each time slot based on the departure/arrival information for each passenger, and determine a movement path of a vehicle based on the passenger movement flow vector for each time slot.

According to a third aspect of the present disclosure, there may be provided a computer-readable recording medium having recorded thereon a program for causing a computer to execute the method according to the first aspect.

In addition, other methods and systems for implementing the present disclosure, and a computer-readable recording medium having recorded thereon a computer program for executing the methods may be further provided.

### Advantageous Effects

According to the present disclosure, it is possible to carry more passengers within a unit time, and thus increase the profitability of a transportation system.

### DESCRIPTION OF DRAWINGS

FIG. 1 is a diagram schematically illustrating an example environment of a traffic information providing system, according to an embodiment.

FIG. 2 is a diagram for describing a method of determining a passenger movement flow vector, according to an embodiment.

FIGS. 3A to 3C are diagrams for describing a method of determining a passenger movement flow vector for each time slot, according to an embodiment.

FIG. 4 is a diagram for describing an example of determining a movement path of a vehicle by generating boarding and alighting clusters, according to an embodiment.

FIG. 5 is a diagram for describing an example of vehicle allocation considering the number of passengers moving between a pair of clusters, according to an embodiment.

FIG. 6 is a diagram for describing a method for returning of a vehicle, according to an embodiment.

FIG. 7 is a flowchart of a method of determining a movement path of a vehicle considering a movement flow of passengers, according to an embodiment.

FIG. 8 is a block diagram of a traffic information providing apparatus according to an embodiment.

### BEST MODE

The present disclosure relates to a method and apparatus for determining a movement path of a vehicle considering a movement flow of passengers.

In the method according to an embodiment of the present disclosure, boarding/alighting information for each time slot for each of a plurality of boarding/alighting points may be obtained, and departure/arrival information for each passenger may be obtained based on the boarding/alighting information for each time slot. In addition, in the method according to an embodiment of the present disclosure, at least one passenger movement flow vector for each time slot may be determined based on the departure/arrival information for each passenger, and a movement path of a vehicle may be determined based on the passenger movement flow vector for each time slot.

### MODE FOR INVENTION

Advantages and features of the present disclosure and a method for achieving them will be apparent with reference to embodiments of the present disclosure described below together with the attached drawings. The present disclosure may, however, be embodied in many different forms and should not be construed as being limited to the embodiments set forth herein, and all changes, equivalents, and substitutes that do not depart from the spirit and technical scope of the present disclosure are encompassed in the present disclosure. These embodiments are provided such that the present disclosure will be thorough and complete, and will fully convey the concept of the present disclosure to those of skill in the art. In describing the present disclosure, detailed explanations of the related art are omitted when it is deemed that they may unnecessarily obscure the gist of the present disclosure.

Terms used herein are for describing particular embodiments and are not intended to limit the scope of the present disclosure. Singular forms are intended to include plural forms as well, unless the context clearly indicates otherwise. As used herein, terms such as “comprises,” “includes,” or “has” specify the presence of stated features, numbers, stages, operations, components, parts, or a combination thereof, but do not preclude the presence or addition of one or more other features, numbers, stages, operations, components, parts, or a combination thereof.

Some embodiments of the present disclosure may be represented by functional block components and various processing operations. Some or all of the functional blocks may be implemented by any number of hardware and/or software elements that perform particular functions. For example, the functional blocks of the present disclosure may be embodied by at least one microprocessor or by circuit components for a certain function. In addition, for example, the functional blocks of the present disclosure may be implemented by using various programming or scripting languages. The functional blocks may be implemented by using various algorithms executable by one or more processors. Furthermore, the present disclosure may employ known technologies for electronic settings, signal processing, and/or data processing. Terms such as “mechanism”, “element”, “unit”, or “component” are used in a broad sense and are not limited to mechanical or physical components.

In addition, connection lines or connection members between components illustrated in the drawings are merely exemplary of functional connections and/or physical or circuit connections. Various alternative or additional functional connections, physical connections, or circuit connections between components may be present in a practical device.

Hereinafter, the term ‘vehicle’ may refer to all types of transportation instruments with engines that are used to move passengers or goods, such as cars, buses, motorcycles, kick scooters, or trucks.

In addition, a ‘traffic information providing system’ may include collecting and analyzing traffic information for a demand-responsive transportation system, and in the demand-responsive transportation system, a movement path of a vehicle may be determined to be of a fixed type, a semi-fixed type, a semi-dynamic type, or a dynamic type.

In addition, a ‘vector’ refers to a quantity with a magnitude and a direction, and hereinafter, a ‘passenger movement flow vector’ may include information about a movement flow (i.e., direction) of passengers and the number (i.e., magnitude) of passengers included in the movement flow.

In addition, the term ‘boarding/alighting point’ refers to a location where passengers may board or alight from a vehicle, and particular passengers may board a vehicle and other passengers may alight from the vehicle at a boarding/alighting point. In an embodiment, a ‘boarding/alighting point’ may be a predetermined location, and in another embodiment, a ‘boarding/alighting point’ may correspond to any location where a vehicle may stop.

Hereinafter, the present disclosure will be described in detail with reference to the accompanying drawings.

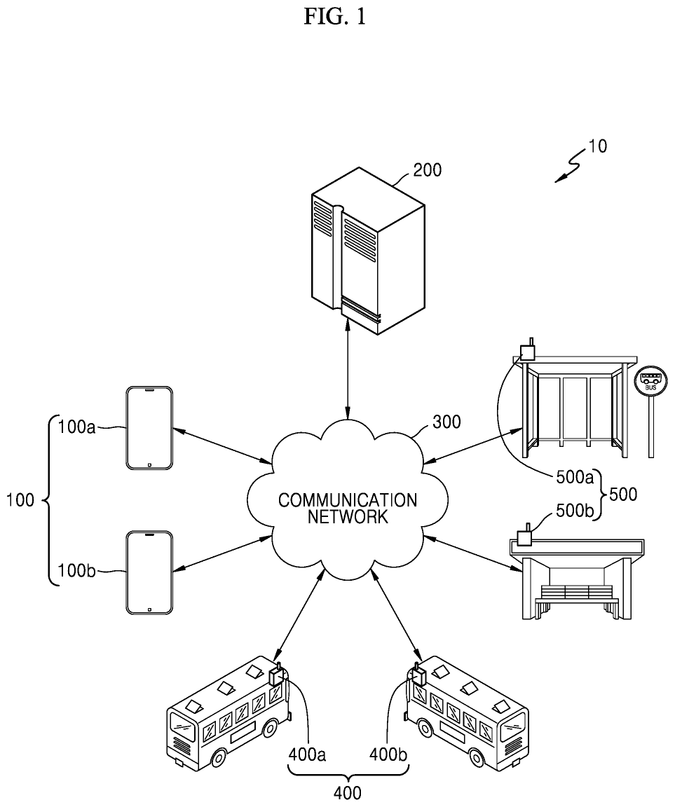

FIG. 1 is a diagram schematically illustrating an example environment of a traffic information providing system, according to an embodiment.

Referring to FIG. 1, a traffic information providing system 10 may include a user terminal 100, a traffic information providing apparatus 200, and a communication network 300. In addition, the traffic information providing system 10 according to an embodiment of the present disclosure may further include a transportation means terminal 400 and/or a boarding/alighting point terminal 500.

Referring to FIG. 1, the traffic information providing system 10 may include the user terminal 100, the traffic information providing apparatus 200, the communication network 300, the transportation means terminal 400, and the boarding/alighting point terminal 500.

The user terminal 100 may refer to a device for receiving traffic information generated by the traffic information providing system 10. The user terminal 100 may refer to a communication terminal capable of transmitting and receiving data to and from other devices in a wired/wireless communication environment. A plurality of user terminals 100 may be included in the traffic information providing system 10.

The user terminal 100 may be, for example, a smart phone, a personal computer (PC), a tablet PC, a smart television (TV), a mobile phone, a personal digital assistant (PDA), a laptop computer, a media player, a microserver, a global positioning system (GPS) device, an electronic book terminal, a digital broadcast terminal, a navigation device, a kiosk, an MP3 players, a digital camera, a wearable device, and any one of other mobile or non-mobile computing devices. In addition, the user terminal 100 may include various devices capable of receiving a touch input, such as electronic blackboards or touch tables. Also, the user terminal 100 may be an accessory such as a watch, glasses, a hair band, or a ring having a communication function and a data processing function.

Although FIG. 1 illustrates that a first user terminal 100a and a second user terminal 100b are smart phones, but the spirit of the present disclosure is not limited thereto, and as described above, any device capable of transmitting and receiving data to and from other devices in a wired/wireless communication environment may be used without limitation.

The user terminal 100 may receive traffic information from the traffic information providing apparatus 200. The user terminal 100 may transmit traffic information to the traffic information providing apparatus 200. That is, the user terminal 100 may transmit and receive traffic information to and from the traffic information providing apparatus 200. The user terminal 100 may display transmitted and received traffic information on a display unit of the terminal through visual signals, may output transmitted and received traffic information through a speaker of the user terminal 100 as auditory signals, and may indicate transmitted and received traffic information through a vibration function of the user terminal 100.

The user terminals 100 may be distinguished from each other according to the location of each user terminal 100. For example, user terminals located at a first boarding/alighting point may be first user terminals 100a, user terminals located inside a particular means of transportation may be second user terminals 100b, and user terminals located at a second boarding/alighting point may be third user terminals 100c. The user terminals 100 distinguished from each other according to their locations may transmit different types of traffic information to the traffic information providing apparatus 200 and may receive different types of traffic information from the traffic information providing apparatus 200.

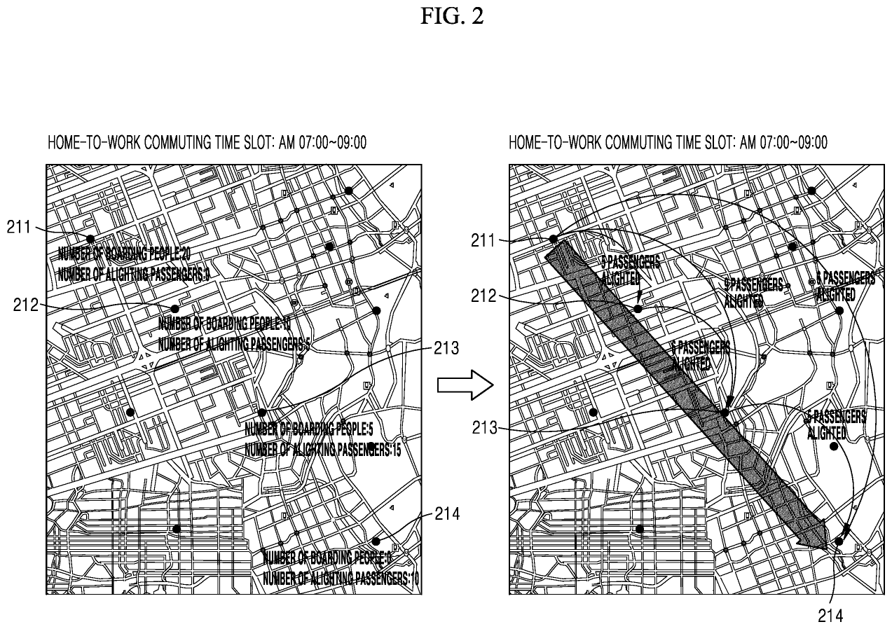

The traffic information providing apparatus 200 may refer to a device for providing traffic information to the user terminal 100. The traffic information providing apparatus 200 may provide information about a current location, an estimated time of arrival to a particular boarding/alighting point, an estimated degree of congestion, an estimated number of remaining seats, and the like of a particular means of transportation. The traffic information providing apparatus 200 may provide the user terminal 100 with recommendation data regarding a recommendation to board a particular means of transportation. Functions of the traffic information providing apparatus 200 will be described in more detail below with reference to FIG. 2.

Here, the traffic information providing apparatus 200 may be a server for providing traffic information. Although FIG. 1 illustrates one server, a plurality of servers may exist according to the amount of access or data.

The estimated degree of congestion of the means of transportation refers to a numerical value for estimating the number of passengers on board the means of transportation, and may be calculated from the type, size, internal area, internal volume, and passenger capacity of the means of transportation, or the number of passengers currently on board the means of transportation in comparison to the total number of seats in the means of transportation. The estimated number of remaining seats of the means of transportation refers to a numerical value for estimating the number of vacant seats in the means of transportation, and may be calculated from the number of passengers currently on board the means of transportation in comparison to the total number of seats in the means of transportation.

The traffic information providing apparatus 200 may transmit different pieces of traffic information to different user terminals 100. Also, the traffic information providing apparatus 200 may receive different pieces of traffic information from different user terminals 100. For example, the traffic information providing apparatus 200 may receive, from the first user terminals 100a located at a first boarding/alighting point, information about the types of means of transportation that users of the terminals want to board, or information about destinations of the users of the terminals. In addition, the traffic information providing apparatus 200 may receive, from the second user terminals 100b located inside a particular means of transportation, information about boarding/alighting points at which users of the terminals want to alight from the means of transportation. In addition, the traffic information providing apparatus 200 may receive, from the third user terminals 100c located at a second boarding/alighting point, information about the types of means of transportation that users of the terminals want to board, or information about destinations of the users of the terminals. In addition, the traffic information providing apparatus 200 may transmit, to the first user terminals 100a and/or the third user terminals 100c, information about a current location, an estimated time of arrival to a particular boarding/alighting point, an estimated degree of congestion, an estimated number of remaining seats, and the like of a particular means of transportation.

The communication network 300 may serve to connect the user terminal 100 and the traffic information providing apparatus 200 to each other. That is, the communication network 300 refers to a communication network that provides an access path such that data including traffic information may be transmitted and received between the user terminal 100 and the traffic information providing apparatus 200. The network 300 may include, for example, a wired network such as a local area network (LAN), a wide area network (WAN), a metropolitan area network (MAN), or an integrated services digital network (ISDN), or a wireless network such as a wireless LAN (WLAN), code-division multiple access (CDMA), Bluetooth, or satellite communication, but the scope of the present disclosure is not limited thereto.

The transportation means terminal 400 may be a device installed in a means of transportation. Here, the means of transportation refers to various means of transportation operating along a route, and may be any one of various means of transportation for carrying passengers among means of transportation such as buses, trains, subways, ships, and airplanes, but is not limited thereto. Although FIG. 1 illustrates that the means of transportation is a bus, the spirit of the present disclosure is not limited thereto, and as described above, various types of means of transportation may be used without limitation.

The transportation means terminal 400 may be a device for transmitting, to the traffic information providing apparatus 200, traffic information related to the means of transportation in which the transportation means terminal 400 is installed. The transportation means terminal 400 may refer to a communication terminal capable of transmitting and receiving data to and from other devices in a wired/wireless communication environment.

A plurality of transportation means terminals 400 may be included in the traffic information providing system 10. That is, as illustrated in FIG. 1, a first transportation means terminal 400a may be installed in a first means of transportation, and a second transportation means terminal 400b may be installed in a second means of transportation. Each transportation means terminal 400 may transmit, to the traffic information providing apparatus 200, information about the means of transportation in which the transportation means terminal 400 is installed.

In addition, the transportation means terminal 400 may be a device for receiving, from the traffic information providing apparatus 200, traffic information related to the means of transportation in which the transportation means terminal 400 is installed. In addition, the transportation means terminal 400 may be a device for transmitting and receiving traffic information to and from other transportation means terminals. That is, the first transportation means terminal 400a and the second transportation means terminal 400b may transmit and receive traffic information obtained by each of them, to and from each other. Although FIG. 1 illustrates that the transportation means terminal is installed outside the means of transportation, the transportation means terminal may be installed inside the means of transportation.

In addition to a function of transmitting and receiving traffic information related to the means of transportation in which the transportation means terminal 400 is installed, the transportation means terminal 400 may perform a function of obtaining such traffic information. For example, the transportation means terminal 400 may perform a function of counting the number of passengers inside the means of transportation, a function of counting the number of seated passengers inside the means of transportation, a function of counting the number of people boarding the means of transportation, a function of counting the number of passengers alighting from the means of transportation, a function of counting the number of passengers to alight from the means of transportation at a particular boarding/alighting point, a function of calculating a degree of congestion of the means of transportation, etc. The transportation means terminal 400 may include a device such as a sensor necessary for counting the number of passengers or the number of passengers boarding or alighting from the means of transportation. Alternatively, the transportation means terminal 400 may be connected to a device for obtaining the traffic information, in a wired or wireless manner.

The boarding/alighting point terminal 500 may be a communication device installed at a boarding/alighting point. Here, the boarding/alighting point may be a building, a structure, or a location on a route on which the means of transportation operates, where the means of transportation stops for boarding and alighting of passengers, but is not limited thereto.

The boarding/alighting point terminal 500 may be a device for transmitting, to the traffic information providing apparatus 200, traffic information related to the boarding/alighting point where the boarding/alighting point terminal 500 is installed. The boarding/alighting point terminal 500 may refer to a communication terminal capable of transmitting and receiving data to and from other devices in a wired/wireless communication environment.

A plurality of boarding/alighting point terminals 500 may be included in the traffic information providing system 10. That is, as illustrated in FIG. 1, a first boarding/alighting point terminal 500a may be installed at a first boarding/alighting point, and a second boarding/alighting point terminal 500b may be installed at a second boarding/alighting point. Each boarding/alighting point terminal 500 may transmit, to the traffic information providing apparatus 200, information about the boarding/alighting point where the boarding/alighting point terminal 500 is installed.

In addition, the boarding/alighting point terminal 500 may be a device for receiving, from the traffic information providing apparatus 200, traffic information related to the boarding/alighting point where the boarding/alighting point terminal 500 is installed.

Also, the boarding/alighting point terminal 500 may be a device for transmitting and receiving traffic information to and from other boarding/alighting point terminals. That is, the first boarding/alighting point terminal 500a and the second boarding/alighting point terminal 500b may transmit and receive traffic information obtained by each of them, to and from each other. Although FIG. 1 illustrates that the boarding/alighting point terminal 500 is installed to be attached to an outer wall of the boarding/alighting point, but the boarding/alighting point terminal 500 may be installed at any one of various positions of the boarding/alighting point or a region near the boarding/alighting point, depending on the location or type of the boarding/alighting point.

In addition to a function of transmitting and receiving traffic information related to the boarding/alighting point where the boarding/alighting point terminal 500 is installed, the boarding/alighting point terminal 500 may perform a function of obtaining the traffic information. For example, the boarding/alighting point terminal 500 may perform a function of counting the number of people waiting at the boarding/alighting point where the boarding/alighting point terminal 500 is installed, a function of counting the number of people who want to board a particular means of transportation among the people waiting at the boarding/alighting point, a function of counting the number of alighting passengers at the boarding/alighting point, etc. The boarding/alighting point terminal 500 may include a device such as a sensor necessary for counting the number of people. Alternatively, the boarding/alighting point terminal 500 may be connected to a device for obtaining the traffic information, in a wired or wireless manner.

FIG. 2 is a diagram for describing a method of determining a passenger movement flow vector, according to an embodiment.

Referring to FIG. 2, a plurality of boarding/alighting points are displayed on a map of FIG. 2. The traffic information providing apparatus may obtain boarding/alighting location information for a plurality of boarding/alighting points. For example, the traffic information providing apparatus may obtain the boarding/alighting location information from boarding/alighting point terminals or user terminals.

The traffic information providing apparatus may obtain information about the numbers of boarding and alighting passengers at each of the plurality of boarding/alighting points considering time points of boarding/alighting of the passengers.

Referring to FIG. 2, the traffic information providing apparatus may obtain the numbers of boarding and alighting passengers at each of the plurality of boarding/alighting points during a home-to-work commuting time slot (07:00 AM to 09:00 AM). The numbers of boarding and alighting passengers at a first boarding/alighting point 211 may be respectively 20 and 0, the numbers of boarding and alighting passengers at a second boarding/alighting point 212 may be respectively 10 and 5, the numbers of boarding and alighting passengers at a third boarding/alighting point 213 may be respectively 5 and 15, and the numbers of boarding and alighting passengers at a fourth boarding/alighting point 214 may be respectively 0 and 10.

The traffic information providing apparatus may determine a passenger movement flow vector based on the numbers of boarding and alighting passengers at the first to fourth boarding/alighting points 211 to 214.

In detail, based on the numbers of boarding and alighting passengers at the first and second boarding/alighting points 211 and 212, the traffic information providing apparatus may determine that the number of passengers who have boarded at the first boarding/alighting point 211 and then alighted at the second boarding/alighting point 212 is 5. Accordingly, it may be seen that the number of remaining passengers who have boarded the vehicle at the first boarding/alighting point 211 is 15 (20−5=15), and the number of passengers on board the vehicle is 25 (15+10=25).

Based on the numbers of boarding and alighting passengers at the first boarding/alighting point 211, the second boarding/alighting point 212, and the third boarding/alighting point 213, the traffic information providing apparatus may estimate that the number of passengers who have boarded at the first boarding/alighting point 211 and then alighted at the third boarding/alighting point 213 is 9 (15×(15/25)=9), and that the number of passengers who have boarded at the second boarding/alighting point 212 and then alighted at the third boarding/alighting point 213 is 6 (15×(10/25)=6). In the estimation process, 15 is the number of passengers who have alighted at the third boarding/alighting point 213.

Finally, based on the numbers of boarding and alighting passengers at the first boarding/alighting point 211, the second boarding/alighting point 212, the third boarding/alighting point 213, and the fourth boarding/alighting point 214, the traffic information providing apparatus may estimate that the number of passengers who have boarded at the first boarding/alighting point 211 and then alighted at the fourth boarding/alighting point 214 is 6, the number of passengers who have boarded at the second boarding/alighting point 212 and then alighted at the fourth boarding/alighting point 214 is 4, and the number of passengers who have boarded at the third boarding/alighting point 213 and then alighted at the fourth boarding/alighting point 214 is 5.

The traffic information providing apparatus may determine at least one passenger movement flow vector representing a flow and a magnitude of a passenger movement in a corresponding time slot, by obtaining boarding/alighting information for each time slot for each of the plurality of boarding/alighting points, and obtaining departure/arrival information for each passenger based on the boarding/alighting information for each time slot. Referring to FIG. 2, a passenger movement flow vector is indicated by a thick arrow, wherein the direction of the arrow represents the movement flow of passengers, and the thickness of the arrow represents the number of passengers included in the movement flow.

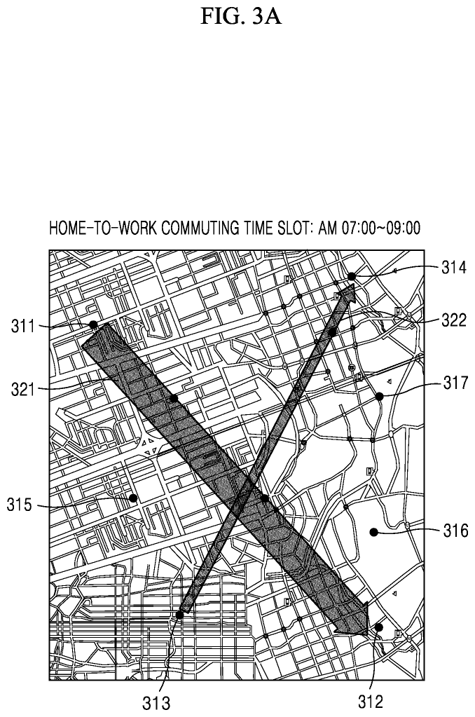

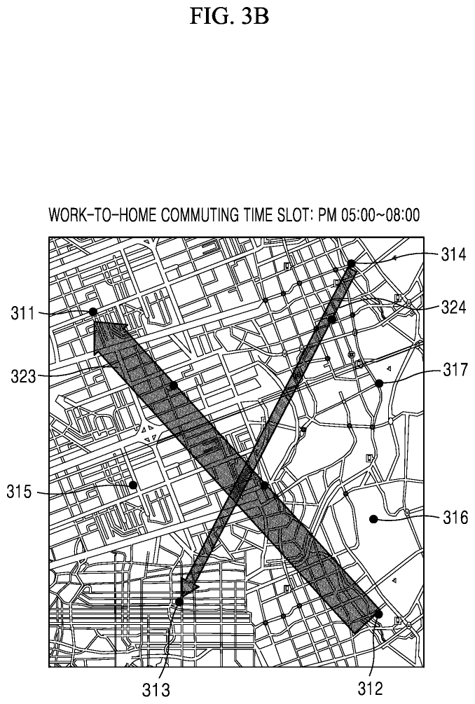

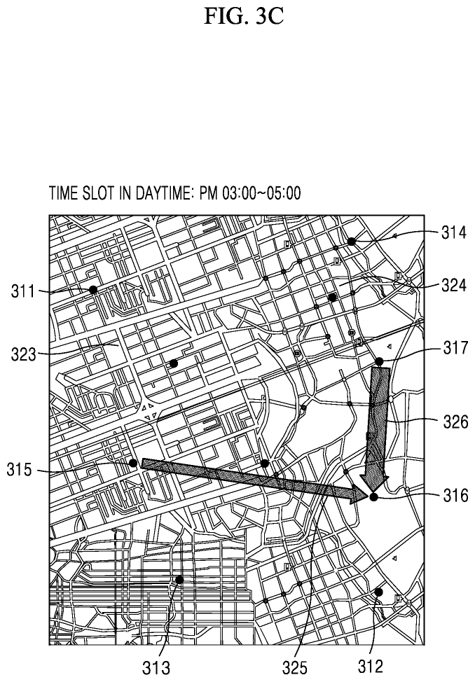

FIGS. 3A to 3C are diagrams for describing a method of determining a passenger movement flow vector for each time slot, according to an embodiment.

Even at the same boarding/alighting point, information about the number of boarding and alighting passengers may vary depending on the time slot. For example, during a home-to-work commuting time slot (07:00 AM to 09:00 PM), there may be a large number of commuting trips of workers from their homes to workplaces, and a large number of commuting trips of students from their homes to schools, during a time slot in daytime (03:00 PM to 05:00 PM), there may be a large number of trips of students from school to a private teaching institutes area, and during a work-to-home commuting time slot (05:00 PM to 08:00 PM), there may be a large number of trips of workers from workplaces to their homes.

During the home-to-work commuting time slot (07:00 AM to 09:00 AM), there may be a large number of passengers boarding at boarding/alighting points located near a residential area, and a large number of passengers alighting at boarding/alighting points located near a commercial area. During the time slot in daytime (03:00 PM to 05:00 PM), there may be a large number of passengers boarding at boarding/alighting points located near a school, and a large number of passengers alighting at boarding/alighting points located near a private teaching institutes area. In contrast to the home-to-work commuting time slot (07:00 AM to 09:00 AM), during the work-to-home commuting time slot (05:00 PM to 08:00 PM), there may be a large number of passengers boarding at boarding/alighting points located near a commercial area, and a large number of passengers alighting at boarding/alighting points located near a residential area.

Referring to FIG. 3A, for the home-to-work commuting time slot (07:00 AM to 09:00 AM), a passenger movement flow vector from a first boarding/alighting point 311 to a second boarding/alighting point 312, and a passenger movement flow vector from a third boarding/alighting point 313 to a fourth boarding/alighting point 314 may be determined. Conversely, referring to FIG. 3B, for the work-to-home commuting time slot (05:00 PM to 08:00 PM), a passenger movement flow vector from the second boarding/alighting point 312 to the first boarding/alighting point 311, and a passenger movement flow vector from the fourth boarding/alighting point 314 to the third boarding/alighting point 313 may be determined. Considering the passenger movement flow vectors for the home-to-work commuting time slot (07:00 AM to 09:00 AM) and the work-to-home commuting time slot (05:00 PM to 08:00 PM), the traffic information providing apparatus may estimate that the first boarding/alighting point 311 and the third boarding/alighting point 313 are in residential areas, and the second boarding/alighting point 312 and the fourth boarding/alighting point 314 are in commercial areas.

In addition, referring to FIG. 3C, for the time slot in daytime (03:00 PM to 05:00 PM), a passenger movement flow vector from a fifth boarding/alighting point 315 to a sixth boarding/alighting point 316, and a passenger movement flow vector from a seventh boarding/alighting point 317 to the sixth boarding/alighting point 316 may be determined. Considering the passenger movement flow vectors for the time slot in daytime (03:00 PM to 05:00 PM), the traffic information providing apparatus may estimate that the fifth boarding/alighting point 315 and the seventh boarding/alighting point 317 are near a school, and the sixth boarding/alighting point 316 is near a private teaching institutes area.

Meanwhile, referring to FIGS. 3A and 3B, it may be seen that the thicknesses of the arrows between the first boarding/alighting point 311 and the second boarding/alighting point 312 are greater than the thicknesses of the arrows between the third boarding/alighting point 313 and the fourth boarding/alighting point 314. As described above in FIG. 2, because the thickness of the arrow corresponds to the magnitude of the passenger movement flow vector, the traffic information providing apparatus may determine that the numbers of passengers included in the movement flows between the first boarding/alighting point 311 and the second boarding/alighting point 312 are greater than the numbers of passengers included in the movement flows between the third boarding/alighting point 313 and the fourth boarding/alighting point 314.

Similarly, referring to FIG. 3C, the traffic information providing apparatus may determine that the number of passengers who have moved from the seventh boarding/alighting point 317 to the sixth boarding/alighting point 316 is great than the number of passengers who have moved from the fifth boarding/alighting point 315 to the sixth boarding/alighting point 316.

The traffic information providing apparatus may determine a passenger movement flow vector for each time slot through the above-described method. The passenger movement flow vector may include information about a movement flow (i.e., a direction) of passengers and information about the number (i.e., a magnitude) of passengers included in the movement flow. The traffic information providing apparatus may determine a movement path of a vehicle based on the passenger movement flow vector.

Hereinafter, determining, by the traffic information providing apparatus, a movement path of a vehicle based on a passenger movement flow vector for each time slot may include determining the movement path of the vehicle by estimating the passenger movement flow vector for each time slot. That is, the traffic information providing apparatus may not only determine a movement path of a vehicle based on a passenger movement flow vector for a particular day of the week and time slot, and but also determine a movement path of a vehicle by estimating a passenger movement flow vector for the same day of the week and time slot as the particular day of the week and time slot.

For example, referring to FIG. 3A, for the home-to-work commuting time slot (07:00 AM to 09:00 AM), considering the directions of a first passenger movement flow vector 321 and a second passenger movement flow vector 322, the traffic information providing apparatus may determine a movement path of a vehicle such that the vehicle starts from the first boarding/alighting point 311 and arrives at the second boarding/alighting point 312, and determine a movement path of a vehicle such that the vehicle starts from the third boarding/alighting point 313 and arrives at the fourth boarding/alighting point 314. In addition, considering the magnitudes of the first passenger movement flow vector 321 and the second passenger movement flow vector 322, the traffic information providing apparatus may perform vehicle allocation scheduling such that the number of vehicles to operate along the first passenger movement flow vector 321 is greater than the number of vehicles to operate along the second passenger movement flow vector 322.

In addition, referring to FIG. 3B, for the work-to-home commuting time slot (05:00 PM to 08:00 PM), considering the directions of a third passenger movement flow vector 323 and a fourth passenger movement flow vector 324, the traffic information providing apparatus may determine a movement path of a vehicle such that the vehicle starts from the second boarding/alighting point 312 and arrives at the first boarding/alighting point 311, and determine a movement path of a vehicle such that the vehicle starts from the fourth boarding/alighting point 314 and arrives at the third boarding/alighting point 313. In addition, considering the magnitudes of the third passenger movement flow vector 323 and the fourth passenger movement flow vector 324, the traffic information providing apparatus may perform vehicle allocation scheduling such that the number of vehicles to operate along the third passenger movement flow vector 323 is greater than the number of vehicles to operate along the fourth passenger movement flow vector 324.

In addition, referring to FIG. 3C, for the time slot in daytime (03:00 PM to 05:00 PM), considering the directions of a fifth passenger movement flow vector 325 and a sixth passenger movement flow vector 326, the traffic information providing apparatus may determine a movement path of a vehicle such that the vehicle starts from the fifth boarding/alighting point 315 or the seventh boarding/alighting point 317 and arrives at the sixth boarding/alighting point 316. In addition, considering the magnitudes of the fifth passenger movement flow vector 325 and the sixth passenger movement flow vector 326, the traffic information providing apparatus may perform vehicle allocation scheduling such that the number of vehicles to operate along the sixth passenger movement flow vector 326 is greater than the number of vehicles to operate along the fifth passenger movement flow vector 325.

In an embodiment, the traffic information providing apparatus may determine a movement path of a vehicle further considering at least one of a boarding period for each passenger and a waiting period for each passenger, in addition to a passenger movement flow vector for each time slot. The boarding period for each passenger may refer to a time period during which the passenger is on board the vehicle, and the waiting period for each passenger may refer to a time period during which the passenger waits outside the vehicle before boarding the vehicle.

The traffic information providing apparatus may calculate a boarding period of a passenger by using the difference between a time point at which the passenger boards the vehicle and a time point at which the passenger alights from the vehicle. In addition, the traffic information providing apparatus may calculate a waiting period of a passenger by using the difference between a time point at which the passenger arrives at a particular boarding/alighting point and a time point at which the passenger boards the vehicle, based on location information of the passenger (e.g., GPS information of a user terminal).

The traffic information providing apparatus may determine a movement path of a vehicle based on a passenger movement flow vector, and determine a final movement path by adjusting the movement path of the vehicle such that boarding periods of passengers on board the vehicle are less than a first threshold value and waiting periods of passengers waiting for the vehicle are less than a second threshold value. For example, even after a movement path passing through 10 boarding/alighting points is determined based on a passenger movement flow vector, when a boarding period of a passenger among passengers is greater than the first threshold value (e.g., 1 hour), or a waiting period of a passenger is greater than the second threshold value (e.g., 30 minutes), the traffic information providing apparatus may determine a final movement path by excluding some boarding/alighting points from the movement path.

In the present disclosure, it is possible to improve passenger convenience by determining a movement path of a vehicle further considering at least one of a boarding period for each passenger and a waiting period for each passenger, in addition to a passenger movement flow vector for each time slot.

In an embodiment, the traffic information providing apparatus may update a passenger movement flow vector for each time slot, at preset time intervals. For example, the traffic information providing apparatus may update the passenger movement flow vector at 2-hour intervals.

Also, the traffic information providing apparatus may set an update interval differently according to the magnitude of the passenger movement flow vector. As the number of passengers included in a movement flow increases, the magnitude of the passenger movement flow vector increases, and as the magnitude of the passenger movement flow vector increases, the direction of the passenger movement flow vector may be maintained for a longer time.

In detail, the traffic information providing apparatus may update the passenger movement flow vector at first time intervals when the magnitude of the passenger movement flow vector is greater than or equal to a first threshold value and less than a second threshold value. In addition, the traffic information providing apparatus may update the passenger movement flow vector at second time intervals when the magnitude of the passenger movement flow vector is greater than or equal to the second threshold value. Here, the first time interval may be set to be less than the second time interval.

For example, referring to FIG. 3A, the traffic information providing apparatus may determine that the magnitude of the first passenger movement flow vector 321 is greater than or equal to the second threshold value, and determine that the magnitude of the second passenger movement flow vector 322 is greater than or equal to the first threshold and less than the second threshold. Accordingly, the traffic information providing apparatus may update the first passenger movement flow vector 321 at 1-hour intervals and update the second passenger movement flow vector 322 at 30-minute intervals.

In the present disclosure, as the update interval is set differently according to the magnitude of the passenger movement flow vector, when at least one of the magnitude and direction of the passenger movement flow vector changes at short intervals, the passenger movement flow vector may be updated at shorter intervals than a reference interval. In the present disclosure, it is possible to carry more passengers within a unit time by determining a movement path of a vehicle based on an updated passenger movement flow vector, and scheduling vehicle allocation.

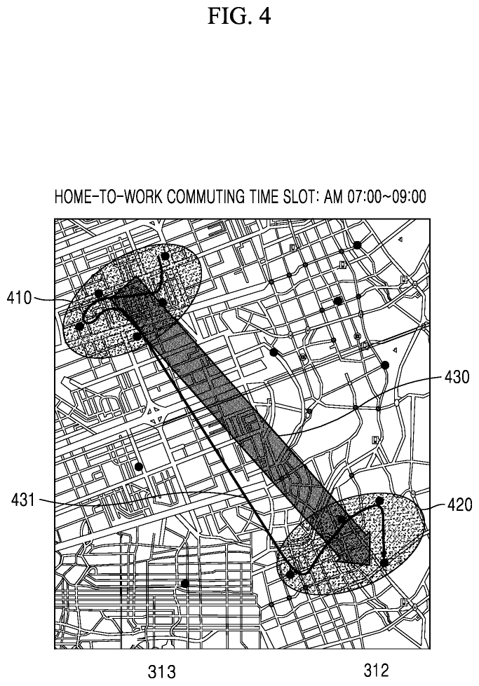

FIG. 4 is a diagram for describing an example of determining a movement path of a vehicle by generating boarding and alighting clusters, according to an embodiment.

The traffic information providing apparatus may generate a boarding cluster 410 by clustering a plurality of boarding/alighting points included in a first region where boarding passengers are concentrated during a certain time slot. In addition, the traffic information providing apparatus may generate an alighting cluster 420 by clustering a plurality of boarding/alighting points included in a second region where alighting passengers are concentrated during a certain time slot. A boarding or alighting cluster is determined for each time slot, and for different time slots, different regions may be determined as boarding or alighting clusters.

Referring to FIG. 4, the traffic information providing apparatus may determine a passenger movement flow vector 430 for a home-to-work commuting time slot (07:00 AM to 09:00 AM) based on departure/arrival information for each passenger for each time slot for each of a plurality of boarding/alighting points. Here, the traffic information providing apparatus may determine the passenger movement flow vector 430 for the home-to-work commuting time slot (07:00 AM to 09:00 AM) by using the boarding cluster 410 and the alighting cluster 420.

In detail, the traffic information providing apparatus may identify a first region where boarding passengers are concentrated during the home-to-work commuting time slot (07:00 AM to 09:00 AM), and generate the boarding cluster 410 by clustering a plurality of boarding/alighting points included in the first region. In addition, the traffic information providing apparatus may identify a second region where alighting passengers are concentrated during the home-to-work commuting time slot (07:00 AM to 09:00 AM), and generate the alighting cluster 420 by clustering a plurality of boarding/alighting points included in the second region. The traffic information providing apparatus may determine the passenger movement flow vector 430 indicated by an arrow, wherein the direction of the arrow may be from the boarding cluster 410 to the alighting cluster 420, and the thickness of the arrow may reflect the number of passengers moving from the boarding cluster 410 to the alighting cluster 420.

Also, the traffic information providing apparatus may determine a final movement path 431 of the vehicle based on the passenger movement flow vector 430.

In detail, the traffic information providing apparatus may determine the final movement path 431 of the vehicle by setting a first movement path connecting the plurality of boarding/alighting points included in the boarding cluster 410, setting a second movement path connecting the plurality of boarding/alighting points included in the alighting cluster 420, and setting a connection path connecting the boarding cluster 410 to the alighting cluster 420. The traffic information providing apparatus may set the first movement path, the second movement path, and the connection path, based on criteria such as shortest times or shortest distances. Also, the traffic information providing apparatus may set the first movement path, the second movement path, and the connection path, further considering at least one of a boarding period for each passenger and a waiting period for each passenger. However, the determination method is not limited thereto.

In addition, the traffic information providing apparatus may determine the number of vehicles to operate on the final movement path 431 in a certain time slot, based on the magnitude of the passenger movement flow vector 430 and the passenger capacity of the vehicle.

In an embodiment, the traffic information providing apparatus may differently set update intervals of passenger movement flow vectors within the boarding/alighting clusters 410 and 420 and an update interval of the passenger movement flow vector 430 between the boarding cluster 410 and the alighting cluster 420. Although not illustrated in FIG. 4, a passenger movement flow vectors according to passenger movements may be determined inside the boarding/alighting clusters 410 and 420.

In detail, the traffic information providing apparatus may determine that the magnitudes of the passenger movement flow vectors inside the boarding/alighting clusters 410 and 420 are less than the second threshold value, and update the passenger movement flow vectors at 30-minute intervals. In addition, the traffic information providing apparatus may determine that the magnitude of the passenger movement flow vector 430 between the boarding cluster 410 and the alighting cluster 420 is greater than or equal to the second threshold value, and update the passenger movement flow vector at 1-hour intervals. For example, a first path and a second path may be updated at 30-minute intervals, and a connection path may be updated at 1-hour intervals.

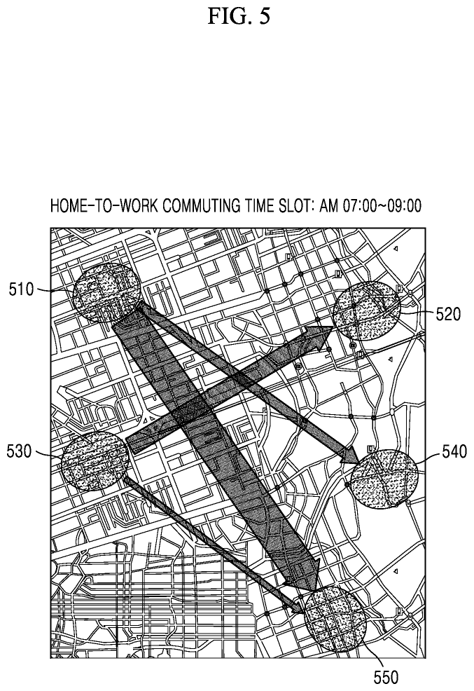

FIG. 5 is a diagram for describing an example of vehicle allocation considering the number of passengers moving between a pair of clusters, according to an embodiment.

The traffic information providing apparatus may generate a plurality of clusters 510, 520, 530, 540, and 550 according to the method described above with reference to FIG. 4. Referring to FIG. 5, the first cluster 510 and the third cluster 530 correspond to boarding clusters, and the second cluster 520, the fourth cluster 540, and the fifth cluster 550 correspond to alighting clusters.

The traffic information providing apparatus may generate a pair of clusters by matching a boarding cluster with an alighting cluster. A boarding cluster and an alighting cluster connected to each other by a passenger movement flow vector may constitute a pair of clusters. One cluster may belong to a plurality of pairs of clusters, and one cluster may be determined as a boarding cluster for some of a plurality of clusters, and as an alighting cluster for the other clusters.

Referring to FIG. 4, the traffic information providing apparatus may generate a first pair of clusters by matching the first cluster 510 with the fifth cluster 550, and generate a second pair of clusters by matching the first cluster 510 with the fourth cluster 540. In the same manner, the traffic information providing apparatus may generate third to fifth pairs of clusters by matching each of the second cluster 520, the fourth cluster 540, and the fifth cluster 550 with the third cluster 530.

The traffic information providing apparatus may obtain information about the number of operable vehicles.

The traffic information providing apparatus may allocate vehicles by comparing the magnitudes of a plurality of passenger movement flow vectors representing the numbers of passengers, with the number of operable vehicles. When the number of operable vehicles is sufficient, the traffic information providing apparatus may allocate vehicles to each of all pairs of clusters illustrated in FIG. 5. A movement path of a vehicle allocated to a pair of clusters may be determined according to the direction of a passenger movement flow vector corresponding to the pair of clusters. Here, when the vehicles differ from each other in passenger capacity, the traffic information providing apparatus may allocate the vehicles considering the magnitude of each passenger movement flow vector. That is, as the magnitude of the passenger movement flow vector increases, a vehicle with a larger passenger capacity may be allocated to the movement path corresponding to the passenger movement flow vector.

Meanwhile, when the number of operable vehicles is not sufficient, the traffic information providing apparatus may allocate vehicles to pairs of clusters of which the magnitudes of the passenger movement flow vectors are greater than or equal to a preset value, considering the information about the number of operable vehicles. For example, when only two vehicles are operable, the traffic information providing apparatus may allocate the vehicles to the first pair of clusters (matching of the first cluster 510 with the fifth cluster 550) and the third pair of clusters (matching of the third cluster 530 with the second cluster 520) of which the magnitudes of the passenger movement flow vectors are large (i.e., the arrows representing of the passenger movement flow vectors are thick). In this case, when the two vehicles differ from each other in passenger capacity, the traffic information providing apparatus may allocate the vehicle with a larger passenger capacity to the first pair of clusters.

In the present disclosure, by allocating vehicles to pairs of clusters considering information about the number of operable vehicles, it is possible to carry more passengers within a unit time.

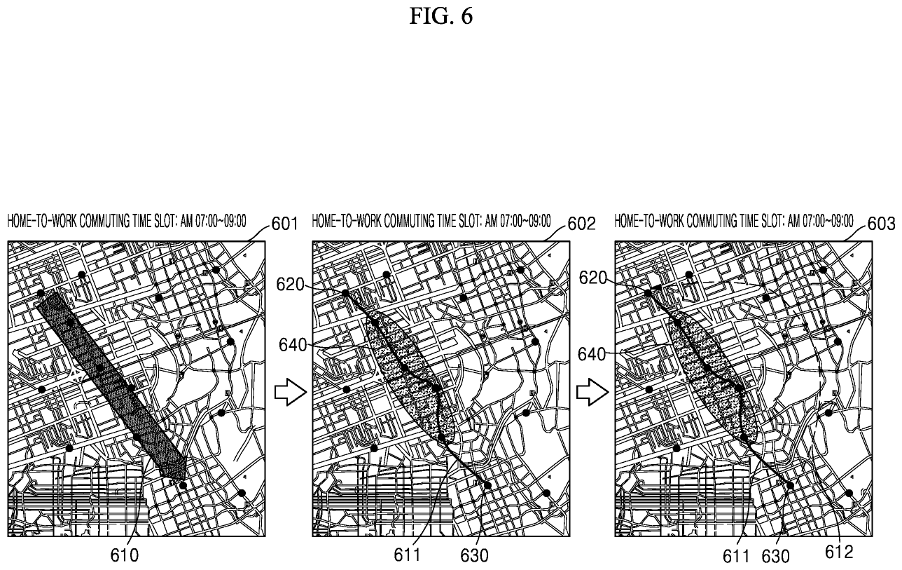

FIG. 6 is a diagram for describing a method for returning of a vehicle, according to an embodiment.

The traffic information providing apparatus may determine a passenger movement flow vector for each time slot based on boarding/alighting location information for a plurality of boarding/alighting points, and information about the numbers of boarding and alighting passengers for each time slot reflecting time points of boarding and alighting of passengers at each of the plurality of boarding/alighting points. In a first map 601 of FIG. 6, a passenger movement flow vector 610 for the home-to-work commuting time slot (07:00 AM to 09:00 AM) is illustrated.

Referring to a second map 602 of FIG. 6, the traffic information providing apparatus may determine a first movement path 611 of a vehicle based on the passenger movement flow vector 610. The traffic information providing apparatus may determine the first movement path 611 passing through boarding/alighting points used to determine the passenger movement flow vector 610. Meanwhile, as described above, the traffic information providing apparatus may determine the moving path of the vehicle by further considering at least one of a boarding period for each passenger and a waiting period for each passenger.

The traffic information providing apparatus may identify a starting point 620, intermediate points 640, and a destination 630 from among a plurality of boarding/alighting points, based on the first movement path 611 of the vehicle.

A third map 603 of FIG. 6 illustrates an example in which the vehicle travels from the starting point 620 to the destination 630 through the intermediate points 640 along the first movement path 611 and then returns to the starting point 620.

In an embodiment, the traffic information providing apparatus may determine a return path 612 of the vehicle such that, when the vehicle returns to the starting point 620 after arriving at the destination 630, the vehicle returns directly to the starting point 620 without passing through the intermediate points 640.

In another embodiment, the traffic information providing apparatus may determine the return path 612 of the vehicle such that, when the vehicle returns to the starting point 620 after arriving at the destination 630, the vehicle passes through at least some of the intermediate points 640 to return to the starting point 620.

In the present disclosure, the return path 612 of the vehicle may be determined by comparing the numbers of passenger movements per unit time for a path passing through at least some of the intermediate points 640, and a path returning directly to the starting point 620 without passing through the intermediate points 640.

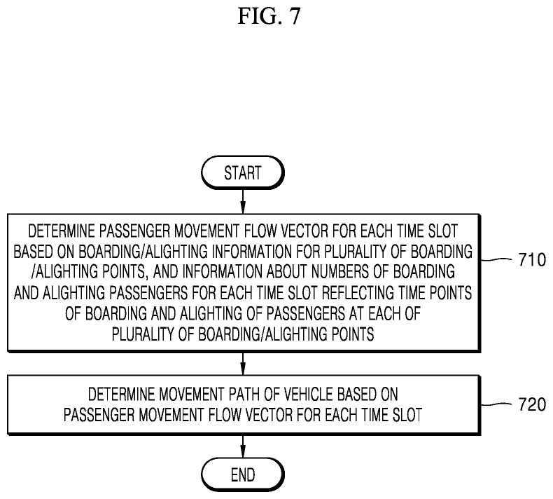

FIG. 7 is a flowchart of a method of determining a movement path of a vehicle considering a movement flow of passengers, according to an embodiment.

The method of determining a movement path of a vehicle illustrated in FIG. 7 is related to the embodiments described above with reference to the drawings, and thus, the descriptions provided above but omitted below may also be applied to the method illustrated in FIG. 7.

Referring to FIG. 7, in operation 710, a processor may obtain boarding/alighting information for each time slot for each of a plurality of boarding/alighting points.

In operation 720, the processor may obtain departure/arrival information for each passenger based on the boarding/alighting information for each time slot.

In operation 730, the processor may determine at least one passenger movement flow vector for each time slot based on the departure/arrival information for each passenger.

The processor may generate a boarding cluster by clustering a plurality of boarding/alighting points included in a first region where a large number of boarding passengers are concentrated during a certain time slot. Also, the processor may generate an alighting cluster by clustering a plurality of boarding/alighting points included in a second region where a large number of alighting passengers are concentrated during the certain time slot. The processor may determine a passenger movement flow vector for the certain time slot based on the boarding cluster and the alighting cluster. The processor may determine a passenger movement flow vector for the certain time slot based on the number of passengers who board in the boarding cluster and then alight in the alighting cluster.

The processor may generate a plurality of pairs of clusters by matching boarding clusters with alighting clusters, and determine a passenger movement flow vector of each of the plurality of pairs of clusters. In addition, the processor may obtain information about the number of operable vehicles, and allocate vehicles to the pairs of clusters of which the magnitudes of the passenger movement flow vectors are greater than or equal to a preset value, considering the information about the number of operable vehicles.

In operation 740, the processor may determine a movement path of the vehicle based on the passenger movement flow vector for each time slot.

The plurality of boarding/alighting points may include a first boarding/alighting point and a second boarding/alighting point. The processor may determine the magnitude of a passenger movement flow vector for a certain time slot based on the number of passengers who board at the first boarding/alighting point and then alight at the second boarding/alighting point during the certain time slot. In addition, the processor may determine a direction of the passenger movement flow vector for the certain time slot based on location information of the first boarding/alighting point and location information of the second boarding/alighting point.

In an embodiment, the processor may update the passenger movement flow vector for each time slot at preset time intervals. The processor may update the passenger movement flow vector for each time slot at first time intervals when the magnitude of the passenger movement flow vector for each time slot is greater than or equal to a first threshold value and less than a second threshold value, and update the passenger movement flow vector for each time slot at first time intervals when the magnitude of the passenger movement flow vector for each time slot is greater than or equal to the second threshold value. Here, the first time interval may be set to be less than the second time interval.

In an embodiment, the processor may determine a movement path of a vehicle further considering the passenger movement flow vector for each time slot, and at least one of a boarding period for each passenger and a waiting period for each passenger.

In an embodiment, the processor may identify a starting point, intermediate points, and a destination from among the plurality of boarding/alighting points, based on the movement path of the vehicle. The processor may determine a return path such that, after the vehicle arrives at the destination, the vehicle returns to the starting point without passing through the intermediate points.

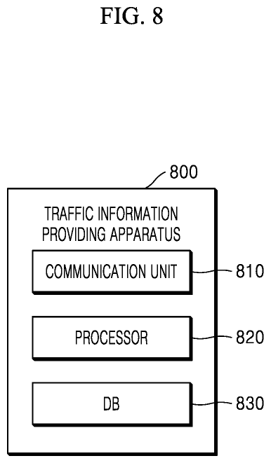

FIG. 8 is a block diagram of a traffic information providing apparatus according to an embodiment.

Referring to FIG. 8, a traffic information providing apparatus 800 may include a communication unit 810, a processor 820 and a database (DB) 830. In the traffic information providing apparatus 800 of FIG. 8, only components related to an embodiment are illustrated. Therefore, it would be understood by those of skill in the art that other general-purpose components may be further included in addition to those illustrated in FIG. 8.

The communication unit 810 may include one or more components for performing wired/wireless communication with an external server or an external device. For example, the communication unit 810 may include at least one of a short-range communication unit (not shown), a mobile communication unit (not shown), and a broadcast receiver (not shown).

The DB 830 is hardware for storing various data processed by the traffic information providing apparatus 800, and may store a program for the processor 820 to perform processing and control. The DB 830 may store payment information, user information, and the like.

The DB 830 may include random-access memory (RAM) such as dynamic RAM (DRAM) or static RAM (SRAM), read-only memory (ROM), electrically erasable programmable ROM (EEPROM), a compact disc-ROM (CD-ROM), a Blu-ray or other optical disk storage, a hard disk drive (HDD), a solid-state drive (SSD), or flash memory.

The processor 820 controls the overall operation of the traffic information providing apparatus 800. For example, the processor 820 may execute programs stored in the DB 830 to control the overall operation of an input unit (not shown), a display (not shown), the communication unit 810, the DB 830, and the like. The processor 820 may execute programs stored in the DB 830 to control the operation of the traffic information providing apparatus 800.

The processor 820 may control at least some of the operations of the traffic information providing apparatus described above with reference to FIGS. 1 to 7.

The processor 820 may be implemented by using at least one of application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, and other electrical units for performing functions.

In an embodiment, the traffic information providing apparatus 800 may be a mobile electronic device. For example, the traffic information providing apparatus 800 may be implemented as a smart phone, a tablet PC, a PC, a smart TV, a PDA, a laptop computer, a media player, a navigation system, a camera-equipped device, and other mobile electronic devices. In addition, the traffic information providing apparatus 800 may be implemented as a wearable device having a communication function and a data processing function, such as a watch, glasses, a hair band, a ring, or the like.

In another embodiment, the traffic information providing apparatus 800 may be an electronic device embedded in a vehicle. For example, the traffic information providing apparatus 800 may be an electronic device that is manufactured and then inserted into a vehicle through tuning.

In another embodiment, the traffic information providing apparatus 800 may be a server located outside a vehicle. The server may be implemented as a computer device or a plurality of computer devices that provide a command, code, a file, content, a service, and the like by performing communication through a network. The server may receive data necessary for determining a movement path of a vehicle from devices mounted on the vehicle, and determine the movement path of the vehicle based on the received data.

An embodiment of the present disclosure may be implemented as a computer program that may be executed through various components on a computer, and such a computer program may be recorded in a computer-readable medium. In this case, the medium may include a magnetic medium, such as a hard disk, a floppy disk, or a magnetic tape, an optical recording medium, such as a CD-ROM or a digital video disc (DVD), a magneto-optical medium, such as a floptical disk, and a hardware device specially configured to store and execute program instructions, such as ROM, RAM, or flash memory.

Meanwhile, the computer program may be specially designed and configured for the present disclosure or may be well-known to and usable by those skilled in the art of computer software. Examples of the computer program may include not only machine code, such as code made by a compiler, but also high-level language code that is executable by a computer by using an interpreter or the like.

According to an embodiment, the method according to various embodiments of the present disclosure may be included in a computer program product and provided. The computer program product may be traded as commodities between sellers and buyers. The computer program product may be distributed in the form of a machine-readable storage medium (e.g., a CD-ROM), or may be distributed online (e.g., downloaded or uploaded) through an application store (e.g., Play Store™) or directly between two user devices. In a case of online distribution, at least a portion of the computer program product may be temporarily stored in a machine-readable storage medium such as a manufacturer's server, an application store's server, or a memory of a relay server.

The operations of the methods described herein may be performed in any suitable order unless otherwise indicated herein or otherwise clearly contradicted by context. The present disclosure is not limited to the described order of the operations. The use of any and all examples, or exemplary language (e.g., ‘and the like’) provided herein, is intended merely to better illuminate the present disclosure and does not pose a limitation on the scope of the present disclosure unless otherwise claimed. Also, numerous modifications and adaptations will be readily apparent to one of ordinary skill in the art without departing from the spirit and scope of the present disclosure.

Accordingly, the spirit of the present disclosure should not be limited to the above-described embodiments, and all modifications and variations which may be derived from the meanings, scopes and equivalents of the claims should be construed as failing within the scope of the present disclosure.

1. A method of determining a movement path of a vehicle considering a movement flow of passengers, the method comprising:
obtaining boarding/alighting information for each time slot for each of a plurality of boarding/alighting points;
obtaining departure/arrival information for each passenger based on the boarding/alighting information for each time slot;
determining at least one passenger movement flow vector for each time slot based on the departure/arrival information for each passenger; and
determining a movement path of a vehicle based on the passenger movement flow vector for each time slot.

2. The method of claim 1, wherein
the plurality of boarding/alighting points comprise a first boarding/alighting point and a second boarding/alighting point, and
the determining of the passenger movement flow vector for each time slot comprises
determining a magnitude of a passenger movement flow vector for a certain time slot based on the number of passengers who board at the first boarding/alighting point and alight at the second boarding/alighting point during the certain time slot, and
determining a direction of the passenger movement flow vector for the certain time slot based on location information of the first boarding/alighting point and location information of the second boarding/alighting point.

3. The method of claim 1, wherein the determining of the passenger movement flow vector for each time slot comprises:
generating a boarding cluster by clustering a plurality of boarding/alighting points included in a first region where a large number of boarding passengers are concentrated during a certain time slot;
generating an alighting cluster by clustering a plurality of boarding/alighting points included in a second region where a large number of alighting passengers are concentrated during the certain time slot; and
determining a passenger movement flow vector for the certain time slot based on the boarding cluster and the alighting cluster.

4. The method of claim 3, wherein the determining of the passenger movement flow vector for each time slot comprises:
generating a plurality of pairs of clusters by matching boarding clusters with alighting clusters;
determining a passenger movement flow vector of each of the plurality of pairs of clusters;
obtaining information about the number of operable vehicles; and
allocating vehicles to pairs of clusters of which magnitudes of passenger movement flow vectors are greater than or equal to a preset value, considering the information about the number of operable vehicles.

5. The method of claim 1, further comprising updating the passenger movement flow vector for each time slot at predetermined time intervals,
wherein the updating comprises,
based on a magnitude of the passenger movement flow vector for each time slot being greater than or equal to a first threshold value and less than a second threshold value, updating at first time intervals, and
based on the magnitude of the passenger movement flow vector for each time slot being greater than or equal to the second threshold value, updating at second time intervals.
wherein the first time interval is different from the second time interval.

6. The method of claim 1, wherein the determining of the movement path of the vehicle comprises determining the movement path of the vehicle further considering the passenger movement flow vector for each time slot, and at least one of a boarding period for each passenger and a waiting period for each passenger.

7. The method of claim 1, further comprising:
identifying a starting point, intermediate points, and a destination from among the plurality of boarding/alighting points, based on the movement path of the vehicle; and
determining a return path such that, after the vehicle arrives at the destination, the vehicle returns to the starting point without passing through the intermediate points.

8. An apparatus for determining a movement path of a vehicle considering a movement flow of passengers, the apparatus comprising:
a memory storing at least one program; and
a processor configured to execute the at least one program to perform an operation,
wherein the processor is further configured to
obtain boarding/alighting information for each time slot for each of a plurality of boarding/alighting points,
obtain departure/arrival information for each passenger based on the boarding/alighting information for each time slot,
determine at least one passenger movement flow vector for each time slot based on the departure/arrival information for each passenger, and
determine a movement path of a vehicle based on the passenger movement flow vector for each time slot.

9. A computer-readable recording medium having recorded thereon a program for causing a computer to execute the method of claim 1.
